(19) United States
(12) Patent Application Publication
(10) Pub. No.: US 2021/0023679 A1
(43) Pub. Date: Jan. 28, 2021

(54) APPARATUS FOR USE WITH A CLAMP

(71) Applicant: Brian Iglesias, Lawrenceville, GA (US)

(72) Inventor: Brian Iglesias, Lawrenceville, GA (US)

(21) Appl. No.: 16/519,258

(22) Filed: Jul. 23, 2019

(51) Int. Cl. B25B 5/00

(52) U.S. Cl. CPC B25B 5/006

(57) ABSTRACT

An apparatus for use with a clamp is disclosed herein. The apparatus includes an elongate body having a right side, a left side, a top side and a bottom side. The apparatus also include a protruding member, an upright member, and a plurality of openings. The apparatus is useful for mechanically and releasably coupling with a utility clamp in order to hold the clamp in position on a work surface without the use of any welding or other semi-permanent fasteners.

### FIELD OF THE INVENTION

The present disclosure relates generally to work holders and more particularly to utility clamp accessories.

### BACKGROUND OF THE INVENTION

There are many types of clamps, pliers, wrenches and vices that have two jaws and are designed to bring the two jaws into clamping contact to one another. Typically, in a clamp for example, the concept is to enable the user to have considerable mechanical advantage, generally through use of a threaded shaft and a crank, to compress the jaws together with a great deal of force, perhaps several hundred pounds even with simple home shop clamps.

A C-clamp or is a type of clamp device typically used to hold a wood or metal work piece, and often used in, but are not limited to, carpentry and welding. Often believed that these clamps are called “C” clamps because of their C-shaped frame, or also often called G-clamps or G-cramps because including the screw part they are shaped like an uppercase letter G, but in fact they were originally called a carriage makers clamp, or Carriage Clamp.

C-clamps or G-clamps are typically made of steel or cast iron, though smaller clamps may be made of pot metal. At the top of the “C” is usually a small flat edge. At the bottom is a threaded hole through which a large threaded screw protrudes. One end of this screw contains a flat edge of similar size to the one at the top of the frame, and the other end usually a small metal bar, perpendicular to the screw itself, which is used to gain leverage when tightening the clamp. When the clamp is completely closed, the flat end of the screw is in contact with the flat end on the frame. When the clamp is actually used, it is very rare that this occurs. Generally some other object or objects will be contained between the top and bottom flat edges.

There are many varieties of C-clamps sold on the market today. Some tradesmen elect to attach their preferred C-clamp to a workbench of choice for repeated usage in specialized positions. However, arrangements such as these often require a user to create a specialized assembly or even apply specialized welds in order to hold the clamp in place. This may ruin the C-clamp or require the user to purchase additional C-clamps for other uses. A suitable solution is required.

### BRIEF DESCRIPTION OF THE DRAWINGS

FIG. 1 is a side view a clamp coupled to an apparatus for use with a clamp.

FIG. 2 is an upper perspective view of the apparatus for use with a clamp highlighting an upright member, a plurality of protrusions, and a protruding member.

### DETAILED DESCRIPTION

Reference will now be made in detail to the present preferred embodiments, examples of which are illustrated in the accompanying drawings. All terms in the plural shall also be taken as singular and vice-versa. Further, any reference to he shall also be applicable to she and vice-versa.

The object of this disclosure generally includes an apparatus for use with a clamp. The apparatus may include an attachment that allows a user to couple an existing clamp of choice to a stationary object or surface without welding. The apparatus may be especially suited for use with clamps that include a threaded hole and sliding arm. A user may pull the sliding arm off and turn it around approximately 180 degrees. The user may then flip the clamp upside down and slide the head into the apparatus and then attach a bolt or other fastener. The apparatus may then be screwed into place on a wood table or welded down on a metal table, while leaving the clamp free to be used elsewhere at a later time.

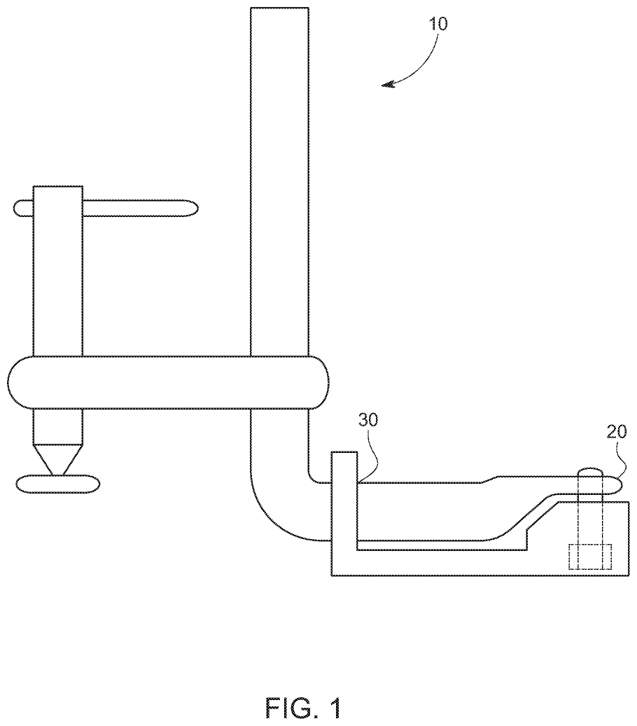

Referring now to FIG. 1, a side view a clamp 10 coupled to an apparatus 100 (not numbered here) for use with a clamp 10. The clamp 10 for use with the apparatus 100 of this disclosure may include a first portion 20 and a second portion 30. The first portion 20 and second portion 30 of the clamp 10 may be configured to have different depths and dimensions.

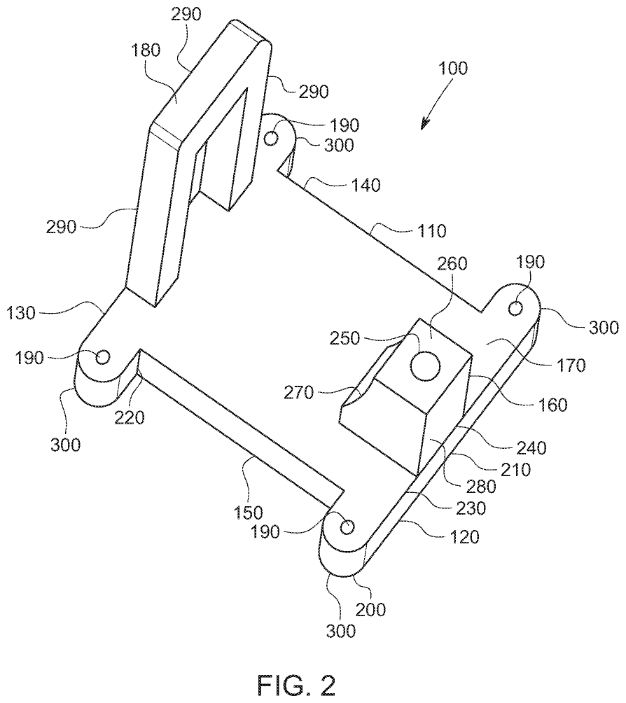

Referring now to FIG. 2, there is an upper perspective view of the apparatus 100 for use with a clamp 10 (see FIG. 1). The apparatus 100 may include an elongate body 110 having a right side 120, a left side 130, a top side 140, and a bottom side 150. Each of the right side 120, left side 130, top side 140 and bottom side 150 may feature at least one curved portion 200 and at least one noncurved portion 210. The top side 140 and the bottom side 150 may also have at least one indent 220. The apparatus may also include a protruding member 160, an upright member 180 and a plurality of openings 190.

Continuing with FIG. 2, the protruding member 160 may be located on an upper surface 170 of the elongate body 110. More specifically, the protruding member may be located on a middle portion 240 of an outer periphery 230 of the upper surface 170 of the elongate body 110. The protruding member 160 may further be configured in such a manner to couple with the first portion 20 of the clamp 10 (see FIG. 1). In addition, the protruding member 160 may have a square-shaped top surface 260 that includes an aperture 250. The protruding member 160 may also have a curved side 270 that allows a clamp 10 to rest more uniformly against it. The aperture 250 may be configured to receive a fastener or other holding element that provides additional stability to the clamp 10 while holding it in position. Further still, a right side of the protruding member 280 may be arranged in a flush manner with a portion of the right side 120 of the elongate body 110.

The upright member 180 may also be located on the upper surface 170 of the elongate body 100. The upright member 180 may be configured to house the second portion 30 (see FIG. 1) of the clamp 10. The upright member may comprise a plurality of segments 290. In a preferred embodiment, the number of segments may equal 3 (three). At least on side of the upright member 180 may be arranged in a flush manner with a portion of the left side 130 of the elongate body 110. The protruding member 160 and upright member 180 hold a clamp 10 in position without the need of spot welds or permanent connecting pieces.

As discussed above, the apparatus 100 may include a plurality of openings 190. The openings 190 may be located on the upper surface 170 of the elongate body 100. In a preferred embodiment, the exact number of openings 190 may equal 4 (four). Each of the plurality of openings 190 may be located on one of a plurality of protrusions 300 on the upper surface 170 of the elongate body 110. Each of the openings 190 is configured to receive a fastening element. The fastening element used may be selected from a wide range of common hardware elements including screws, bolts, brads, rivets, and the like.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. An apparatus for use with a clamp, said apparatus comprising:
an elongate body having a right side, a left side, a top side and a bottom side;
a protruding member, said protruding member being located on an upper surface of said elongate body and configured to be coupled to a first portion of a clamp;
an upright member, said upright member located on said upper surface of said elongate body and configured to house a second portion of said clamp;
a plurality of openings, said plurality of openings being located on said upper surface of said elongate body and wherein each of said plurality of openings is configured to receive a fastening element;
wherein each of said right side, left side, top side and bottom side has at least one curved portion and at least one noncurved portion; and
wherein said top side and said bottom side has at least one indent.

2. The apparatus of claim 1, wherein said protruding member is located on an outer periphery of said upper surface of said elongate body.

3. The apparatus of claim 2, wherein said protruding member is located on a middle portion of said outer periphery of said upper surface of said elongate body.

4. The apparatus of claim 1, wherein said protruding member has an aperture on a top surface of said protruding member.

5. The apparatus of claim 4, wherein said top surface of said protruding member is square-shaped.

6. The apparatus of claim 1, wherein said protruding member has a curved side.

7. The apparatus of claim 3, wherein a right side of said protruding member is flush with a portion of said right side of said elongate body.

8. The apparatus of claim 1, wherein said upright member has a plurality of segments.

9. The apparatus of claim 8, wherein said plurality of segments is 3 segments.

10. The apparatus of claim 1, wherein said upright member is located on an outer periphery of said upper surface of said elongate body.

11. The apparatus of claim 1, wherein at least one side of said upright member is flush with a portion of said left side of said elongate body.

12. The apparatus of claim 1, wherein said plurality of openings is 4 openings.

13. The apparatus of claim 1, wherein each of said plurality of openings is located on one of a plurality of protrusions of said upper surface of said elongate body.

14. An apparatus for use with a clamp, said apparatus comprising:
an elongate body having a right side, a left side, a top side and a bottom side;
a protruding member, said protruding member being located on an upper surface of said elongate body and configured to be coupled to a first portion of a clamp;
an upright member, said upright member located on said upper surface of said elongate body and configured to house a second portion of said clamp;
a plurality of openings, said plurality of openings being located on said upper surface of said elongate body and wherein each of said plurality of openings is configured to receive a fastening element;
wherein each of said right side, left side, top side and bottom side has at least one curved portion and at least one noncurved portion;
wherein said top side and said bottom side has at least one indent;
wherein said protruding member is located on an outer periphery of said upper surface of said elongate body;
wherein said protruding member is located on a middle portion of said outer periphery of said upper surface of said elongate body;
wherein said protruding member has an aperture on a top surface of said protruding member;
wherein said top surface of said protruding member is square-shaped;
wherein said protruding member has a curved side;
wherein a right side of said protruding member is flush with a portion of said right side of said elongate body;
wherein said upright member has a plurality of segments;
wherein said plurality of segments is 3 segments;
wherein said upright member is located on an outer periphery of said upper surface of said elongate body;
wherein at least one side of said upright member is flush with a portion of said left side of said elongate body;
wherein said plurality of openings is 4 openings; and
wherein each of said plurality of openings is located on one of a plurality of protrusions of said upper surface of said elongate body.
